(19) United States
(12) Patent Application Publication
(10) Pub. No.: US 2025/0330101 A1
(43) Pub. Date: Oct. 23, 2025

(54) SOLID-STATE ELECTROMAGNETIC INDUCTION POWER GENERATION SYSTEM

(71) Applicant: Apollo Dynamic Engineering LLC, Bradenton, FL (US)

(72) Inventors: Gene Brown, Sarasota, FL (US); Timothy A. Grega, Bradenton, FL (US)

(73) Assignee: Apollo Dynamic Engineering LLC, Bradenton, FL (US)

(21) Appl. No.: 19/184,822

(22) Filed: Apr. 21, 2025

Related U.S. Application Data
(60) Provisional application No. 63/637,159, filed on Apr. 22, 2024.
(60) Provisional application No. 63/675,347, filed on Jul. 25, 2024.

(51) Int. Cl. H02M 7/44; H02M 1/32

(52) U.S. Cl. CPC H02M 7/44; H02M 1/32

(57) ABSTRACT

A customizable, scalable solid-state electromagnetic induction power generation system that utilizes a software-controlled processor and highspeed switching components to exceed the performance and efficiency of conventional power systems. The system is readily modifiable to use conventional DC power and/or renewable energy sources for conversion into single or three-phase AC power for use in personal and commercial electronic applications.

### CROSS-REFERENCES TO RELATED APPLICATIONS

This application claims priority of and incorporates by reference provisional patent application 63/675,347, filed Jul. 25, 2024, and provisional patent application 63/637,159, filed Apr. 22, 2024.

### STATEMENT REGARDING FEDERALLY SPONSORED RESEARCH OR DEVELOPMENT

Not applicable.

### REFERENCE TO SEQUENCE LISTING OR COMPUTER PROGRAM LISTING APPENDIX

Not applicable.

### BACKGROUND

This section provides background information related to the present disclosure which is not necessarily prior art.

Conventional rotary excitation systems, which date back to the early 20th century, rely on rotating machines to provide the excitation current needed for the magnetic field in generators. These systems use a small generator mounted on the same shaft as the main generator to produce direct current (“DC”), which is fed into the rotor winding of the main generator to create a magnetic field necessary for induction to occur in the stator winding. This mechanical coupling has been the backbone of electrical generation for decades. However, these systems have not been without drawbacks, such as mechanical wear and tear, inefficiencies due to slip rings and brushes, and limited control over the excitation current.

The desire to overcome these limitations led to the development of static (or solid-state) excitation systems. These systems have the ability to convert alternating current (“AC”) to DC (and vice versa) without moving parts. This innovation significantly reduced maintenance and increased reliability. Additionally, these systems utilize power electronics to control the flow of electricity precisely, providing fast, accurate control over the generator's magnetic field. This capability is crucial for modern power systems, which require rapid adjustments to maintain stability under varying load conditions.

Despite these advances, solid-state power systems still have much room for improvement. What is lacking in the prior art is a solid-state, processor-controlled, scalable induction power system capable of harnessing a variety of different energy inputs, such as DC power and renewable energy sources, to output single phase as well as three phase AC power to power personal and commercial electrical devices.

### SUMMARY

The present disclosure relates generally to power induction systems. More specifically, the present disclosure relates to solid-state, processor-controlled DC input to AC output induction systems capable of utilizing singular or multiple different power inputs, including renewable energy sources, that can provide single and three phase AC power output to power personal and commercial electrical devices.

### BRIEF DESCRIPTION OF DRAWINGS

The drawings described herein are for illustrative purposes only of selected embodiments, and not all possible implementations, and are not intended to limit the scope of the present disclosure.

FIG. 1 is a block diagram illustrating a solid-state electromagnetic induction power generation system where a solid-state generator inverts the DC power from a DC source to three-phase AC power to supply electricity to the AC load.

FIG. 2 is a block diagram illustrating a solid-state electromagnetic induction power generation system where a solid-state generator inverts the DC power from a DC source as well as a renewable energy power source to one-phase or three-phase AC power, as selected by a user via a computer controller, to supply electricity to the AC load.

FIG. 3 is a more detailed block diagram illustrating a solid-state electromagnetic induction power generation system where a solid-state generator inverts the DC power from a DC source to AC power to supply electricity to the AC load.

FIG. 4 is a more detailed block diagram illustrating a solid-state electromagnetic induction power generation system where a solid-state generator inverts the DC power from a DC source and a renewable energy power source to AC power to supply electricity to the AC load.

FIG. 5 is a block diagram illustrating with greater detail that portion of the solid-state electromagnetic induction power generation system that comprises the pole module subsystem.

FIG. 6 is a cross section of one embodiment of the solid-state generator.

FIG. 7 is a cross section of another embodiment of the solid-state generator.

FIG. 8 is a simplified block diagram of FIG. 4 that shows a number of the various DC power sources that could be incorporated in various embodiments of the disclosure.

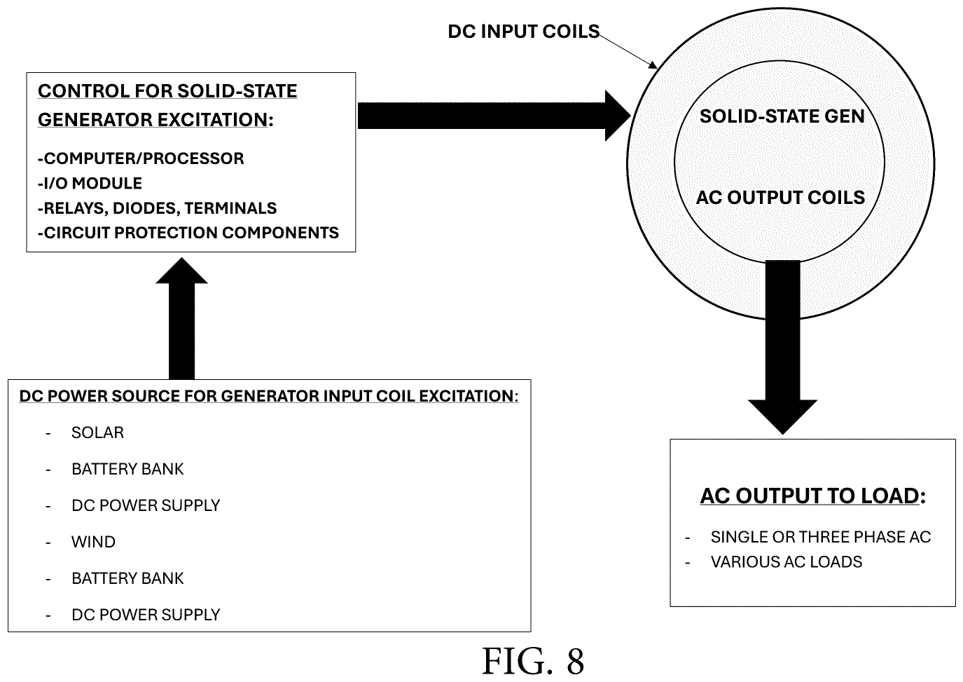

Corresponding reference numerals indicate corresponding parts throughout the several views of the drawings.

Throughout this document, if a power inversion system or a power inverter is used to generate single-phase AC, it can also be applied to three-phase AC without departing from the spirit or scope of the disclosure. If a power inversion system or a power inverter is used to generate three-phase AC, it can also be applied to single-phase AC without departing from the spirit or scope of the disclosure.

Without losing generality, all numerical values given in this disclosure are examples. Other values can be used without departing from the spirit or scope of the disclosure.

### DETAILED DESCRIPTION

While the making and using of various embodiments of the present disclosure are discussed in detail below, it should be appreciated that the present disclosure provides many applicable inventive concepts that can be embodied in a wide variety of specific contexts. The specific embodiments discussed herein are merely illustrative of specific ways to make and use the disclosure and do not delimit the scope of the disclosure. In some example embodiments, well-known processes, well-known device structures, and well-known technologies are not described in detail.

To facilitate the understanding of the embodiments described herein, several terms are defined below. The terms defined herein have meanings as commonly understood by a person of ordinary skill in the areas relevant to the present disclosure. Terms such as “a,” “an,” and “the” are not intended to refer to only a singular entity, but rather include the general class of which a specific example may be used for illustration. Additionally, the word ‘comprising’ does not exclude the presence of other elements or steps than those listed in a claim. The terminology herein is used to describe specific embodiments of the disclosure, but their usage does not delimit the disclosure, except as set forth in the claims.

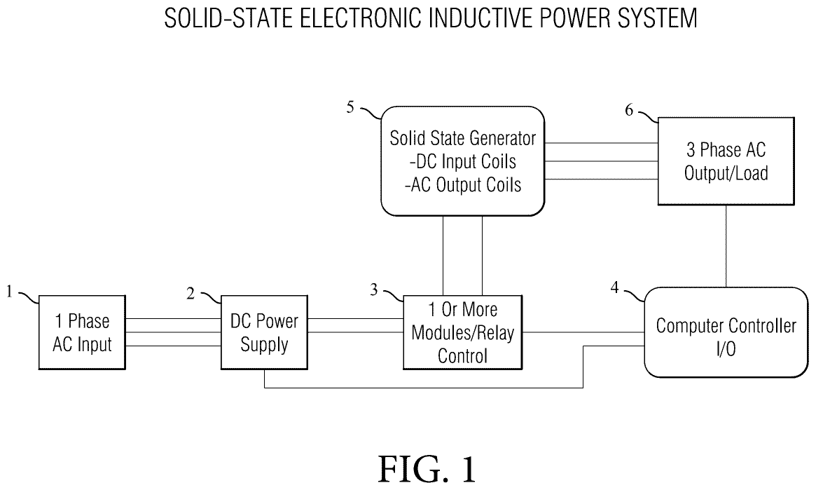

One embodiment of the present disclosure is illustrated in FIG. 1. In this embodiment, AC power 1 is supplied to the SSEIP and rectified via an AC-to-DC power converter device 2. DC power from the AC-to-DC power converter device 2 is provided to a DC bus on which one or more pole modules and relay controls 3 are connected which in turn connect to a computer controller input/output device 4 and a solid-state generator 5. The computer controller input/output device 4 utilizes a human machine interface (“HMI”) for users to input commands, adjust parameters, and monitor data to and from the SSEIP. The solid-state generator 5 is comprised of DC input coils and AC output coils and provides three-phase AC output 6.

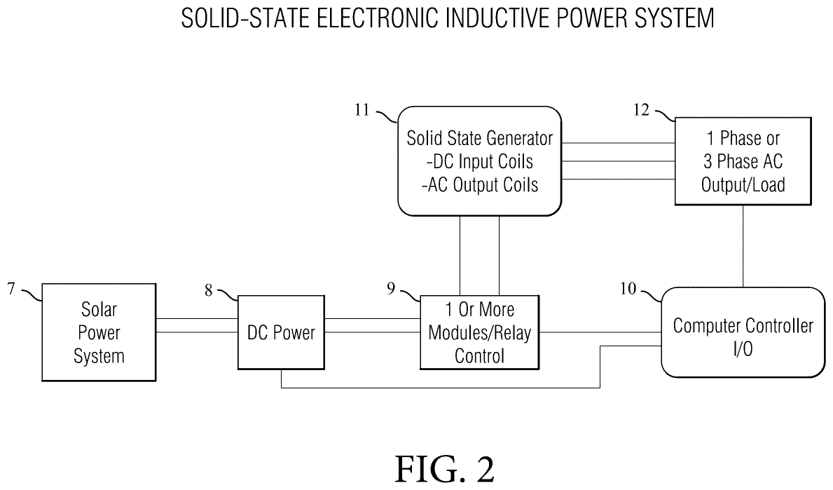

Another embodiment of the present disclosure is illustrated in FIG. 2. In this embodiment, DC power 8 is supplied to the SSEIP via a renewable energy source system/device 7, such as a solar powered device, and/or a battery bank for providing backup power. DC power 8 from the renewable energy source is provided to a DC bus on which one or more pole modules and relay controls 9 are connected which in turn connect to a computer controller input/output device 10 and a solid-state generator 11. The computer controller input/output device 10 utilizes an HMI for users to input commands, adjust parameters, and monitor data to and from the SSEIP. The solid-state generator 11 is comprised of DC input coils and AC output coils and provides one-phase or three-phase AC output 12.

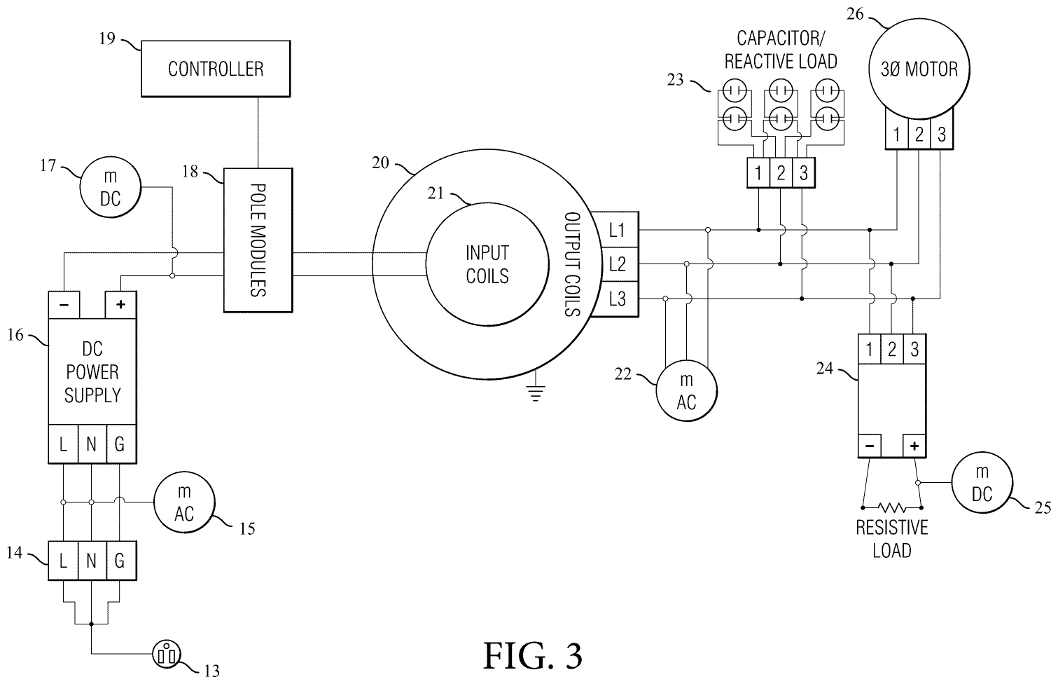

FIG. 3 illustrates a more detailed view of the FIG. 1 embodiment of the SSEIP system. In this embodiment, AC power is supplied to the SSEIP from a 115 VAC wall plug 13 common to residential homes in the United States and rectified via an AC-to-DC power converter device 16. The connection from the wall plug 13 to the AC-to-DC power converter 16 is comprised of common wiring (live-neutral-ground) 14. An AC meter 15 is connected to these wires for displaying amps and voltage at this position in the SSEIP system. DC power from the AC-to-DC power converter device 16 is provided to one or more DC buses on which one or more relay pole modules 18 of the pole module/relay control system 3 are connected which in turn connect to a computer controller 19 and a solid-state generator 5. The connection from the AC-to-DC power converter 16 to the DC bus on which one or more pole modules 18 are connected is comprised of common wiring connected to the positive and negative terminals of the AC-to-DC power converter 16, with a DC meter 17 for displaying amps and voltage at this position in the SSEIP system. The pole modules 18 provide DC power to input coils 20 of the solid-state generator 5, where the DC power is converted to three-phase AC power and output from output coils 21 of the solid-state generator 5 for AC load usage. The three-phase AC power output by the solid-state generator 5 may be further regulated and/or increased by one or more capacitors 23, as well as one or more additional DC power supplies 26 and full wave diode rectifiers 24 with connected DC meters 25. An AC meter 22 is connected to the output wires of the output coils 21 for displaying amps and voltage at this position in the SSEIP system.

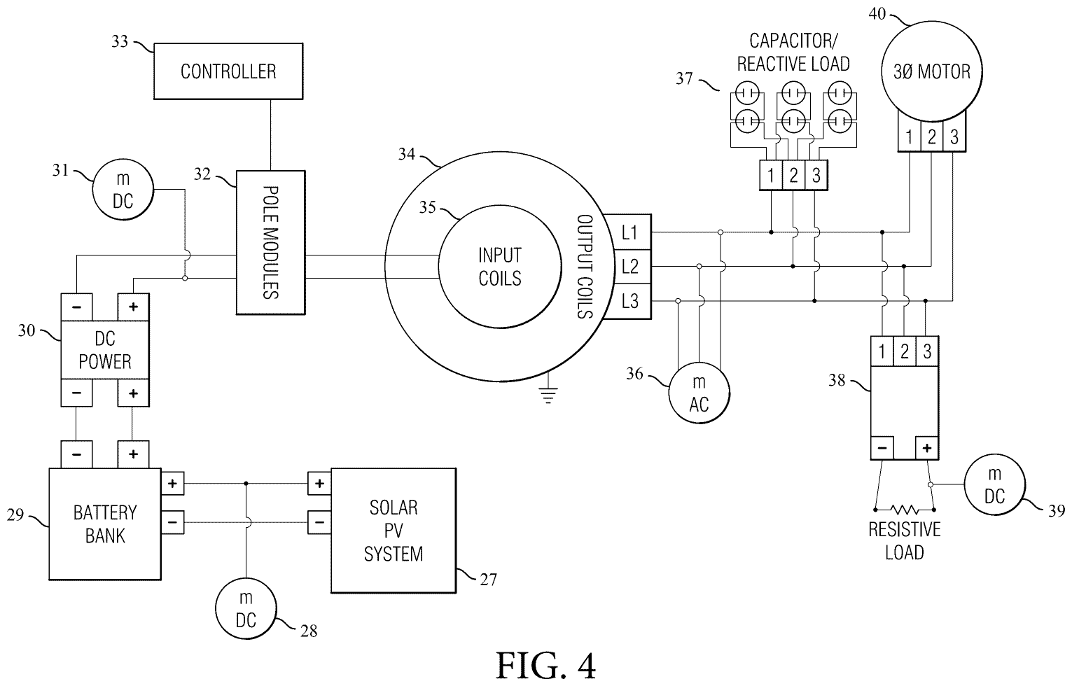

FIG. 4 illustrates a more detailed view of the FIG. 2 embodiment of the SSEIP system. In this embodiment, AC power is supplied to the SSEIP from a solar photovoltaic system 27. The solar photovoltaic system 27 stores DC power generated from the photovoltaic system 27 in a battery bank 29. The photovoltaic system 27 is connected to the battery bank 29 from the positive and negative terminals using common wiring. A DC meter 28 is connected to these wires for displaying amps and voltage at this position in the SSEIP system. The battery bank 29 provides DC power 30 to a DC bus on which one or more relay pole modules 32 of the pole module/relay control system 9 are connected which in turn connect to a computer controller input/output device 33 and a solid-state generator 11. The connection from the battery bank 29 to the DC bus is comprised of common wiring connected to the positive and negative terminals of the battery bank 29, with a DC meter 31 for displaying amps and voltage at this position in the SSEIP system. The pole modules 32 provide DC power to input coils 34 of the solid-state generator 11, where the DC power is converted to three-phase AC power and output from output coils 35 of the solid-state generator 11 for AC load usage. The three-phase AC power output by the solid-state generator 11 may be further regulated and/or increased by one or more capacitors 37, as well as one or more additional DC power supplies 40 and full wave diode rectifiers 38 with connected DC meters 39. An AC meter 36 is connected to the output wires of the output coils 35 for displaying amps and voltage at this position in the SSEIP system.

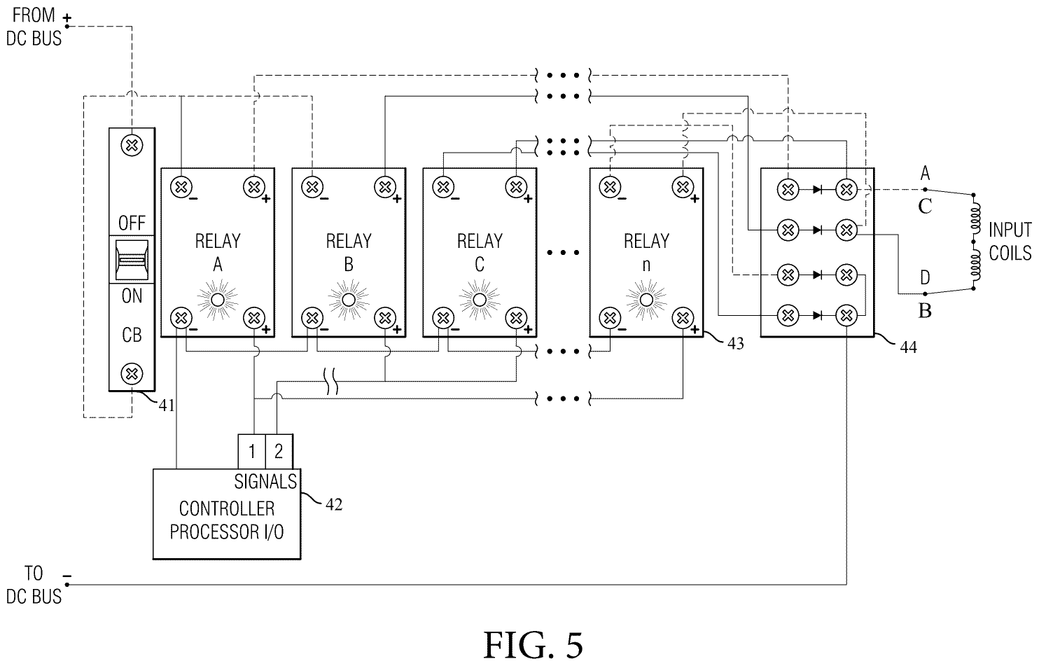

FIG. 5 illustrates a more detailed view of one embodiment of the relay pole modules 18, 32 as well as the connection between the pole module/relay control system 3, 9 and the computer controller input/output system 4, 10. In this embodiment, a DC bus is connected to a relay pole module 18, 32 by common electrical wiring. The relay pole module 18, 32 is composed of a plurality of solid-state relays 43 which are interconnected with one another, a controller processor 42 connected to the computer controller input/output system 4, 10, and the input coils of the solid-state generator 5, 11. The relay pole module 18, 32 is comprised of a circuit breaker 41 that is capable of turning the circuit of the relay pole module 18, 32 “on” or “off” with a manual switch that protects the relay pole module 18, 32 from over current, among other functions. The SSEIP system may be comprised of a plurality of relay pole modules 18, 32 which, in conjunction with the controller processor 42, control DC power input to the input coils. A relay pole module 18, 32 may be configured to control one or more poles in series or in parallel. Diodes 44, of the “schottky type” in one embodiment of the SSEIP system, provide a flyback protection circuit for the pole modules 18, 32, one per relay 43 output.

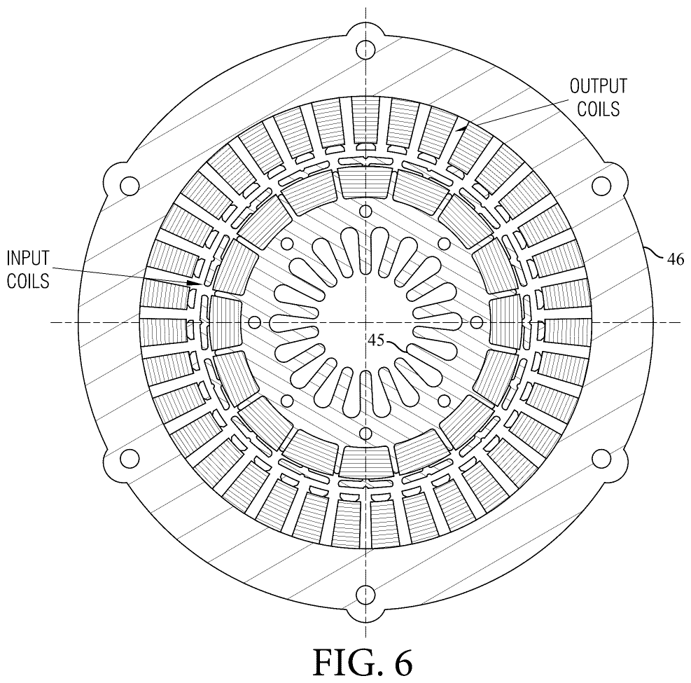

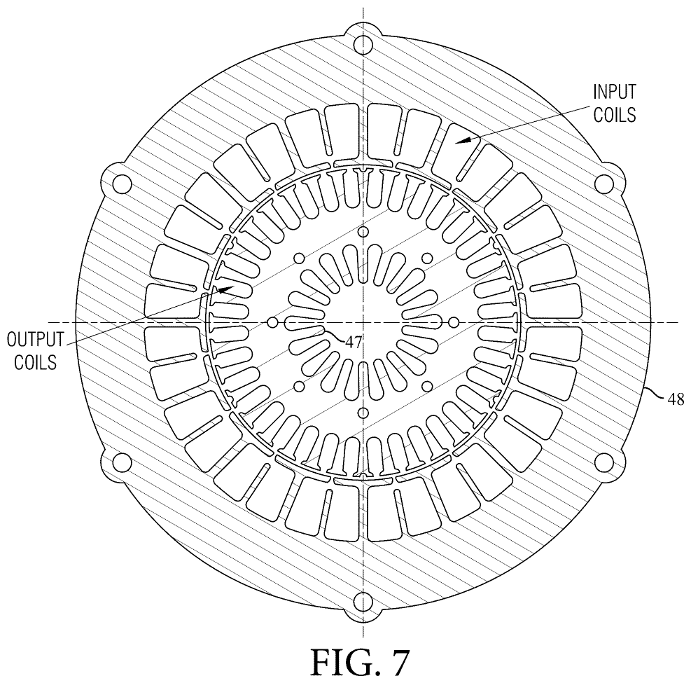

FIG. 6 and FIG. 7 each illustrate two different embodiments of cross sections of the solid-state generator 5, 11. The solid-state generator 5, 11 is comprised of a plurality of input coils 20, 34 and output coils 21, 35. The input coils 20, 34 and output coils 21, 35 are manufactured from high grade electrical steel laminates 45-48 of the type commonly used in conventional generators, motors, and transformers. The input coil 20, 34 may be affixed either inside or outside of the output coil 21, 35. The solid-state generator laminate 45-48 layout is not limited to a singular input coil 20, 34 and a singular output coil 21, 35, but may be comprised of multiple and/or concentric input coils 20, 34 and output coils 21, 35. The solid-state generator laminates 45-48 may be circular in design, but other laminate layout designs are also possible for utilization in the solid-state generator 5, 11, including but not limited to linear or other geometric shapes. In one embodiment, the winding wire for the input coils 20, 34 and output coils 21, 35 is that which is known as “magnet wire” and is commonly used in the electrical industry. In another embodiment, AC output coil windings are wound multi-wire in the “five-in-hand” configuration with AC “WYE” outputs and, in another embodiment, with “DELTA” outputs, as those terms are commonly used in the electrical industry. In another embodiment, DC input coils are wound with multi-wire, multi-turn configurations such that each coil has a North and South termination to interface to an excitation DC bus.

The DC buses is/are comprised of DIN rail terminal blocks for positive & negative DC polarities, but those skilled in the art will recognize that many other types of DC buses may be used in embodiments of the present disclosure.

In one embodiment of the present disclosure, the relay pole modules 18, 32 are comprised of four 1 Normally Open Mosfet Output solid-state relays with LED Optocoupler signal input, a 1 pole DC circuit breaker and four Fast Recovery Epitaxial Diodes.

In one embodiment of the present disclosure, 10 AWG MTW or THHN wire is used for the power circuit and 14 AWG MTW or THHN wire is used for control signal circuits.

In one embodiment of the present disclosure, the capacitor banks 23, 37 are comprised of AC rated non-polarized, oil filled, metallized polypropylene type capacitors, but those skilled in the art will recognize that many other types of capacitor banks may be used in embodiments of the present disclosure.

One or more motors 26, 40 may be used in the SSEIP system as part of the AC load 24, 38 output.

The AC meters 15, 22, 36 are standard “off the shelf” single & three phase meters commonly found and used in the United States by those skilled in the art that monitor voltage, for each phase leg and neutral, amperage, KVA, KW and power factor, but those skilled in the art will recognize that many other types of monitors may be used in embodiments of the present disclosure.

The DC meters 17, 25, 28, 31, 39 are standard “off the shelf” meters commonly found and used in the United States by those skilled in the art that measure DC voltage and amperage, but those skilled in the art will recognize that many other types of monitors may be used in embodiments of the present disclosure.

In one embodiment, the SSEIP system is affixed to a frame assembly. The frame assembly can be oriented in a vertical or horizontal orientation. Covers, cases, and electromagnetic compatibility shielding materials may be utilized to protect the various components of the disclosure and may be affixed to the frame assembly, if a frame assembly is utilized.

A computer controller 4, 10 is used for control and management of the SSEIP system. The controller utilizes two software tasks: one software task is for timing of the pulse generation for relay signals, and the other software task is for all other logic (i.e., PID, AVR, etc.). An HMI is used to input commands, adjust parameters, and monitor data relating to the SSEIP system operation.

The task that controls timing executes cyclically at or around 100 microsecond intervals. The task executes the program unit (designated herein as “Timing”). The Timing program controls the generation of 8 separate signals, or “pulses”, 2 for each relay pole module 18, 32, per relay module set. The 24 VDC output pulses are produced by a plurality of controller 4, 10 input/output cards. The output control cards operate by using absolute time values for when the output state changes. The time value is an unsigned 64-bit integer equal to the number of nanoseconds since Jan. 1, 2000, 00:00 hours. Each pulse start time relative to the period start time, as well as the duration of each pulse, is stored in a text file and read into program variables when the SSEIP system is turned “on”.

Pulse outputs are controlled by sending an absolute time for the output transitions. To begin pulse generation, the internal clock value of the software is captured and stored as the initial time value for future calculation. During each scan of the logic, (i.e., at or near every 100 microseconds), the current time duration is analyzed to capture the beginning of a new pulse cycle. To determine the beginning of a new pulse cycle, the current time accumulation is divided by the period time and if the remainder is less than 250,000 nanoseconds, then a new period has begun, and the period counter is incremented by 1. This process is further illustrated below:

$$Period start = ( Time Accumulation ) module ( Period ) < 250000$$

A “State” machine controls the logic of each pulse output.
State 0: Idle waiting for cycle start. Transition to state 10 when the unit is placed into run mode.
State 10: When a new period has been triggered, the start time of the pulse is calculated and sent to the applicable pole module output control card.

$$Start Time = Initial Time + Period Count * Period Duration + Pulse A 1 ( i . e . , the first signal ) Delay + Task Cycle Time * 4$$

Note, the start time is offset by or around 400 microseconds to allow interaction with the output control card before the start time of the pulse.
State 20: Interaction with output control card for each pole module signal.
State 30: Waits for the pulse to start. After start of the pulse, the time when the pulse is to be turned off is calculated and sent to the output control card.

$$Off Time = Pulse A 1 Start Time + A 1 Duration$$

State 40: Interaction with output control card.
State 50: Wait for pulse to turn off and then return to State 0.

The “Sequence Timing Control” function of the computer controller 4, 10 software is based on the cycle time for 50 Hz, 60 Hz and 400 Hz AC power. One embodiment, based on 60 Hz AC electric power, is as follows in this paragraph 0041. One complete cycle measures at or around 16.6667 milliseconds in duration (at or around 8.3333 milliseconds north and at or around 8.3333 milliseconds south). Two separate signals are used to control the DC voltage, one is for the northside direction and the other is for the southside direction of the applicable input coil, and the signals control the applicable pole module 18, 32 circuit directional switching devices. The aforementioned two signals alternate power on the same coil with a delay between the two signals to dissipate flyback voltage from the collapsing DC coil. The durations of the timing signals are stored in a text file and loaded into variables at the start of the controller through the HMI. Adjustments to duration of the pole signals in milliseconds and adjustment of the delay between the subsequent pole signals in milliseconds are set through the HMI. In this embodiment, there are two pulsed signals per pole of the applicable input coil 20, 34, which control the DC input across the “A” (i.e., north) side of the coil and alternately the “B” (i.e., south) side of the coil.

Task 2 executes the program unit (designated herein as “Main”), cyclically at or around every 1 millisecond. The Main program unit then calls another program unit, “Automatic Voltage Regulation”, or “AVR”. The program unit designated “Proportional, Integral, Derivative” or “PID” input to the controller input/output 4, 10 card may use Hall-effect or current transformers, or similar sensors, for the applicable input coil 20, 34 pole modules 18, 32 and AC voltage output meter 22, 36 of the applicable output coil 21, 35.

The program unit AVR uses a PID function block to regulate the voltage of the DC power supplies to increase or decrease the amount of DC voltage through the pole module switching devices. A set point of desired AC output voltage is set through the HMI.

Alternately, the computer controller 4, 10 can be used to increase or decrease the timing sequence duration. In one embodiment, the generator system with no load (i.e., idle), may require 6.00 milliseconds duration and, as the AC output load increases, the PID program increases the signal timing duration proportionately to 6.75 milliseconds, 7.00 milliseconds, 7.55 milliseconds, and so on, to keep the desired set point AC output voltage.

This software/firmware can be configured for use with a variety of different controller types and applications, including, but not limited to, residential and industrial uses, personal computers, and custom-made processor controllers.

The disclosure has a multitude of advantages over the prior art, a few of which will be described below.

First, the disclosure harnesses a much higher efficiency than conventional rotary excitation systems. By using a solid-state input coil in place of a conventional rotor and using an output coil in place of a conventional stator, highly efficient, stable sinewave AC is produced. The disclosure does not experience the mechanical and electrical efficiency losses associated with conventional gasoline, diesel, propane, hydro/steam power, solar, and wind inverter type generator systems.

Second, the disclosure can be used to convert single phase AC power to three phase AC power. Through software-controlled changes, the output AC power can be configured to different voltages, i.e., 208, 230, 400, 480, 600 VAC as well as different output frequencies, i.e., 50, 60 or 400 Hz. These voltages and frequencies are non-exhaustive.

Third, the disclosure is readily scalable in design for small power applications to large megawatt utility, commercial, and industrial applications.

Fourth, the disclosure is simple to use and customize.

Fifth, the disclosure does not use complex prime mover components utilized in conventional power generation systems.

Sixth, the flexibility and simplicity of the disclosure means the system can be used for mobile applications. This mobility enables a user to move the system to the most ideal location for use in personal or commercial applications. This mobility also enables power usage off-grid, on a micro grid, and in marine, rail, automotive, air, and other vehicle-related applications.

Seventh, the disclosure can be customized in an ergonomic fashion, either with the use of a frame assembly or without, to limit physical strain on humans using the apparatus.

Eighth, compared to conventional power generation systems, and depending on the DC excitation source used, the disclosure uses minimal fossil fuels (if any) and releases minimal (if any) carbon emissions. The disclosure can also utilize renewable energy resources, including but not limited to wind and solar, to further reduce carbon emissions and fossil fuel usage.

Ninth, the disclosure improves over conventional pulse width modulated DC to AC inverter technology because the disclosure utilizes highly efficient processor-controlled switching resulting in minimal to no loss in the conversion of input DC voltage to output DC voltage. As such, the disclosure also functions as a high efficiency DC to AC power inverter, among its various other functions disclosed herein.

Tenth, the disclosure's high efficiency inverter capabilities will significantly improve solar, wind, battery, electric vehicle, marine, and/or mobile systems when integrated with such systems. Typically, most inverter efficiency loss is the result of discreet switching with insulated-gate bipolar transistors (IGBTs) or metal-oxide-semiconductor field-effect transistors (MOSFETs) in the process of converting DC square waves to AC sinewaves with a pulse width modulated circuit. The disclosure's design utilizes minimal controlled switching, resulting in an overall higher efficiency in the conversion of DC power, which is used as an excitement voltage to generate AC voltage power output through AC windings in the disclosure's laminate. Because of the processor-controlled DC excitation input, the AC power output of the disclosure is generated through the disclosure's windings and laminate, and such AC power output offsets the conversion losses that are present with conventional pulse width modulated type DC to AC inverters.

The written description uses examples for disclosure and to enable any person skilled in the art to practice the disclosure, including making and using any materials or processes and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as a limitation of the disclosure. The principal features of this disclosure may be employed in various embodiments without departing from the spirit or scope of the disclosure. Those of ordinary skill in the art will recognize numerous equivalents to the specific procedures described herein. Such equivalents are considered to be within the scope of this disclosure and are covered by the claims.

Thus, although there have been described particular embodiments of the present disclosure of a new and useful SOLID-STATE ELECTROMAGNETIC INDUCTION POWER GENERATION SYSTEM, it is not intended that such references be construed as limitations upon the scope of this disclosure except as set forth in the claims.

We claim:

1. A power conversion system for converting supplied DC power to AC power comprising:
a. a solid-state generator;
b. a processor controller with a human machine interface; and
c. one or more relay pole modules, each comprised of a plurality of relays, diodes, and a circuit breaker.
